(19) United States
(12) Patent Application Publication
(10) Pub. No.: US 2014/0211771 A1
(43) Pub. Date: Jul. 31, 2014

(54) WIRELESS MODEM HAVING TRANSMISSION POWER MANAGEMENT MODES

(71) Applicant: FRANKLIN WIRELESS CORPORATION, San Diego, CA (US)

(72) Inventor: Ok Chae Kim, San Diego, CA (US)

(73) Assignee: Franklin Wireless Corporation, San Diego, CA (US)

(21) Appl. No.: 13/752,105

(22) Filed: Jan. 28, 2013

(51) Int. Cl. H04W 84/12

(52) U.S. Cl. CPC H04W 84/12
USPC 370/338

(57) ABSTRACT

A wireless modem is disclosed. In one aspect, the modem includes at least one wireless interface configured to wirelessly communicate data according to a wireless communication standard. The wireless interface is further configured to use a transmission power to transmit the data. The modem also includes a controller configured to determine a type of power source for the wireless modem and select a transmission power level of the wireless interface based at least partially on the determined power source.

### BACKGROUND

1. Field

The described technology generally relates to a wireless modem, for example a universal serial bus (USB) modem, for communicating data and managing transmission power.

2. Description of the Related Technology

With the proliferation of high speed mobile internet services, an increasing number of wireless modems utilize high bandwidth wireless technologies. Examples of such modems include a USB dongle type modem. A USB dongle type modem can be connected to a USB port of a computing device to provide broadband internet access within the third generation (3G) or fourth generation (4G) wireless networks, and to a portable wireless local area network (WLAN) hot-spot modem.

Long-range wireless communication technologies include code division multiple access (CDMA), global system for mobile (GSM), evolution data only (EVDO), high speed packet access (HSPA), high speed uplink packet access (HSUPA), high speed downlink packet access (HSDPA), evolved HSPA (HSPA+), long term evolution (LTE) and worldwide interoperability for microwave access (WiMax). Those wireless networks are hereinafter referred to as wireless wide area network (WWAN), to be distinguished from short-range wireless networks such as WLAN (or Wi-Fi according to IEEE 802.11 b/g/n), Blue Tooth and Zigbee which cover a limited area, for example, inside a commercial building or residence.

### SUMMARY

One inventive aspect is a wireless universal serial bus (USB) modem comprising: a physical USB interface configured to receive power from a power source, wherein the power source is a computing device or an external power source; a wireless wide area network (WWAN) transceiver configured to transmit and receive WWAN data according to a WWAN communication standard; a wireless local area network (WLAN) transceiver configured to transmit and receive WLAN data according to a WLAN communication standard; and a controller configured to determine the power source that provides power via the physical USB interface and select a transmission power level of each of the WWAN and WLAN transceivers based at least partially on the determined power source.

Another aspect is a wireless modem comprising: at least one wireless interface configured to wirelessly communicate data according to a wireless communication standard, wherein the at least one wireless interface is further configured to use a transmission power to transmit the data; and a controller configured to determine a type of power source for the wireless modem and select a transmission power level of the at least one wireless interface based at least partially on the power source.

Another aspect is a method of operating a wireless modem comprising: wirelessly communicating data according to a wireless communication standard with the use of a transmission power to transmit the data; determining a type of power source for the wireless modem; and selecting a transmission power level for the wireless data communication based at least partially on the determined power source.

Another aspect is one or more processor-readable storage devices having processor-readable code embodied on the processor-readable storage devices, the processor-readable code for programming one or more processors to perform a method of operating a wireless modem comprising: wirelessly communicating data according to a wireless communication standard with the use of a transmission power to transmit the data; determining a type of power source for the wireless modem; and selecting a transmission power level for the wireless data communication based at least partially on the determined power source.

Another aspect is a wireless modem comprising: means for wirelessly communicating data according to a wireless communication standard with the use of a transmission power to transmit the data; means for determining a type of power source for the wireless modem; and means for selecting a transmission power level for the wireless data communication based at least partially on the determined power source.

### BRIEF DESCRIPTION OF THE DRAWINGS

The devices, systems, and methods of the present disclosure have several features, no single one of which is solely responsibly for its desirable attributes. Without limiting the scope of this invention as expressed by the claims which follow, its more prominent features will now be discussed briefly. After considering this discussion, and particularly after reading the section entitled “Detailed Description,” one will understand how the features of this disclosure provide several advantages over other wireless modems.

FIG. 1 is a wireless data communication network that includes a wireless USB modem configured to provide wireless data communication between a client device and a wireless cell site.

FIG. 2 illustrates an exemplary data layer structure for use with the wireless data communication network shown in FIG. 1.

FIG. 3 is a wireless data communication network that includes a wireless USB modem according to one embodiment.

FIG. 4 illustrates an exemplary data layer structure for use with the wireless data communication network shown in FIG. 3.

FIG. 5 is a functional block diagram of one embodiment of the wireless USB modem from FIG. 3.

FIG. 6 is a flowchart showing one exemplary use and operation of the wireless USB modem from FIG. 3.

FIG. 7 illustrates two exemplary screenshots of a web UI that is displayed on a screen of a client device by the wireless USB modem from FIG. 3.

FIG. 8 is a wireless data communication network including a wireless USB modem configured to provide wireless data communication between a client device and wireless networks according to one embodiment.

FIG. 9 is a functional block diagram of one embodiment of the wireless USB modem from FIG. 8.

FIG. 10 illustrates an exemplary physical interface of the wireless USB modem from FIG. 8.

FIG. 11 is a flowchart showing another exemplary use and operation of the wireless USB modem from FIG. 8.

FIG. 12 is a flowchart showing another exemplary use and operation of the wireless USB modem from FIG. 8.

FIG. 13 is a flowchart showing another exemplary use and operation of the wireless USB modem from FIG. 8.

FIG. 14 illustrates an exemplary screenshot of a pop-up notification that is displayed on a screen of a client device by the wireless USB modem from FIG. 8.

### DETAILED DESCRIPTION

Universal serial bus (USB) standardized the connection of computer peripherals, such as keyboards, pointing devices, digital cameras, printers, portable media players, disk drives and network adapters to personal computers, both to communicate and to supply electric power. The power that an USB port of a computing device can supply to the peripheral devices includes, for example, direct current (DC), about +5V, max about 500 mA.

Wireless modems attached to client devices allow wireless data transfer between client devices and cellular cell sites, enable clients to browse the Internet, and to send or receive emails from their computing devices. For the wireless USB modem that has both WWAN and WLAN radio transmission capabilities, the power from the USB port of computing devices is not generally sufficient to have both WWAN and WLAN radios on when the modem receives a weak signal from WWAN base stations. To cope with a rapidly growing demand for wireless data services, WWAN service providers are expanding their WWAN coverage. However, most WWAN operators are currently not able to meet the demand and thus they wish to offload WWAN traffic to other wireless technology such as a public or private WLAN.

In order to connect the USB modem to a client device, the user of the client device installs software in their devices. The software can include, for example, a USB driver and connection manager (CM) software. While USB modem manufacturers offer many USB drivers and CM programs, users still need to select the appropriate driver and program that is compatible with the operation system (OS) of their device.

Wireless USB modems generally have a baseband processor and a radio frequency (RF) unit to process a WWAN signal received from cellular cell sites. A typical wireless USB modem includes a modulator and a demodulator which perform a signal conversion between a USB data signal and a WWAN radio frequency (RF) signal. The wireless USB modem also includes a USB physical connector (e.g., USB port) which allows the modem to communicate data with a client device connected thereto. The USB physical connector also allows the USB modem to receive power from the connected client device.

Embodiments will be described with respect to the accompanying drawings. Like reference numerals refer to like elements throughout the detailed description.

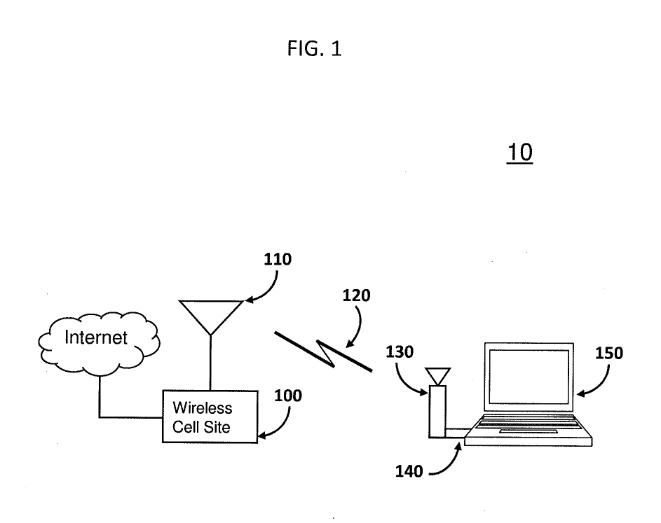

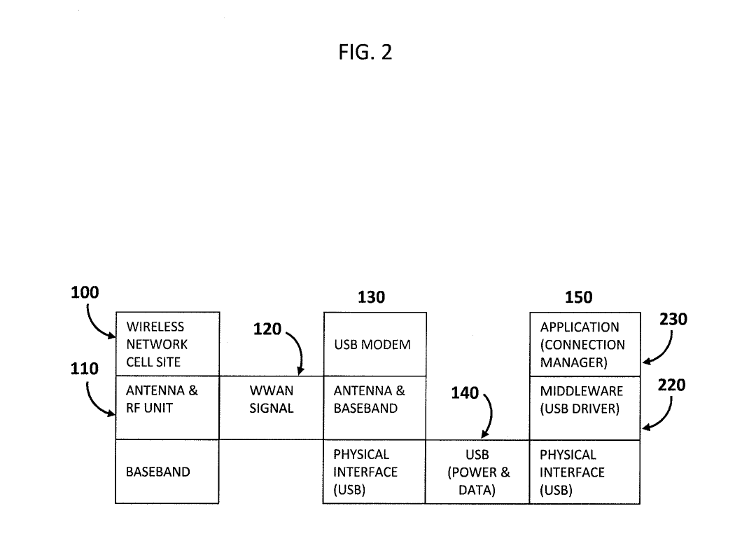

FIG. 1 is a wireless data communication network 10 including a wireless USB modem 130. FIG. 2 illustrates an exemplary data layer structure of the wireless data communication network 10 shown in FIG. 1. The wireless data communication network 10 includes a client device 150 and a wireless network cell site 100. The client device 150 and the wireless network cell site 100 wirelessly communicate RF data with each other via a public wireless network signal 120 such as a WWAN signal provided by, for example, commercial cellular service providers. For the purpose of convenience, the description will be provided based on the public wireless network signal being a WWAN signal. However, the present disclosure is not limited thereto.

The wireless network cell site 100 can be a base station or any other device or system connected to the Internet. An antenna and RF unit 110 is connected to the wireless network cell site 100. The wireless USB modem 130 and the client device 150 establish a USB connection 140 via respective physical USB interfaces (e.g., USB ports). The USB modem 130 receives power from and communicates data with the client device 150 via the established USB interface 140. The wireless USB modem 130 and the antenna and RF unit 110 allow the client device 150 and the wireless network cell site 100 to wirelessly communicate RF data with each other via the WWAN signal 120.

The USB modem 130 may include additional elements (software or hardware) such as an encoder, a decoder and a processor (not shown) so as to convert RF data, received from the cell site 100, to USB data, and transmit the converted data to the client device 150, and to convert USB data, received from the client device 150, to RF data, and transmit the converted data to the cell site 100.

In order to connect the USB modem 130 to the client device 150, a user installs a USB driver (middleware) 220 (see FIG. 2). The user is also prompted to install a connection manager (CM) program 230 which runs on the operating system of the client device 150 and allows the user to control and monitor wireless data transmission status in the cellular network subscribed to by the user. The USB driver 220 and CM programs 230 are typically stored in a USB modem memory or provided in a separate optical storage medium such as a compact disk (CD) or a digital video disk (DVD).

The USB modem 130 provides the physical USB interface 140 for connecting with the single client device 150, which limits its connectivity. For example, when the user plugs the USB modem 130 into another client device, the user must install the appropriate USB driver and CM software into the other client device. Furthermore, the USB modem 130 does not operate as a standalone device even if the modem 130 receives power from an external power source because the modem 130 cannot wirelessly communicate data with a client device. Moreover, USB Modem manufacturers have to provide different USB driver and CM programs which are compatible with various operation systems of different client devices such as Windows, Macintosh, Linux, Android and iOS.

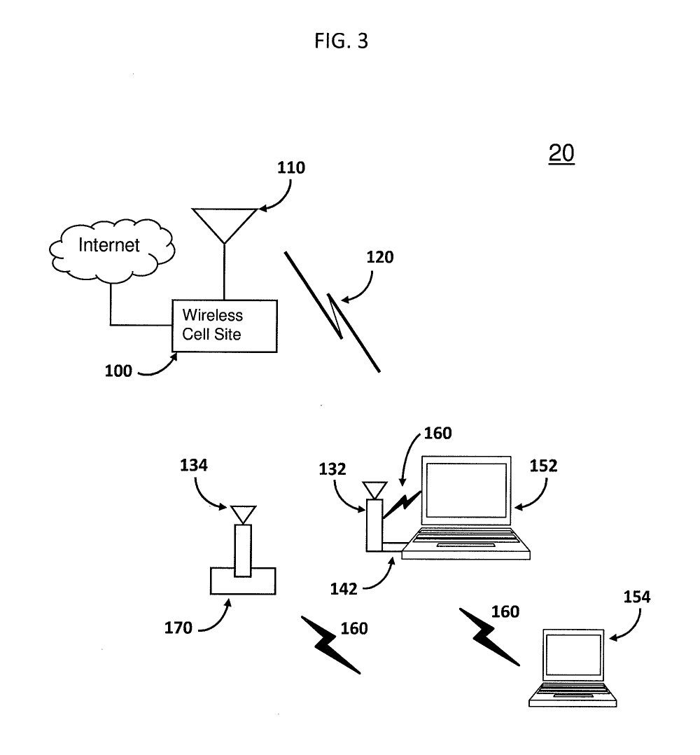

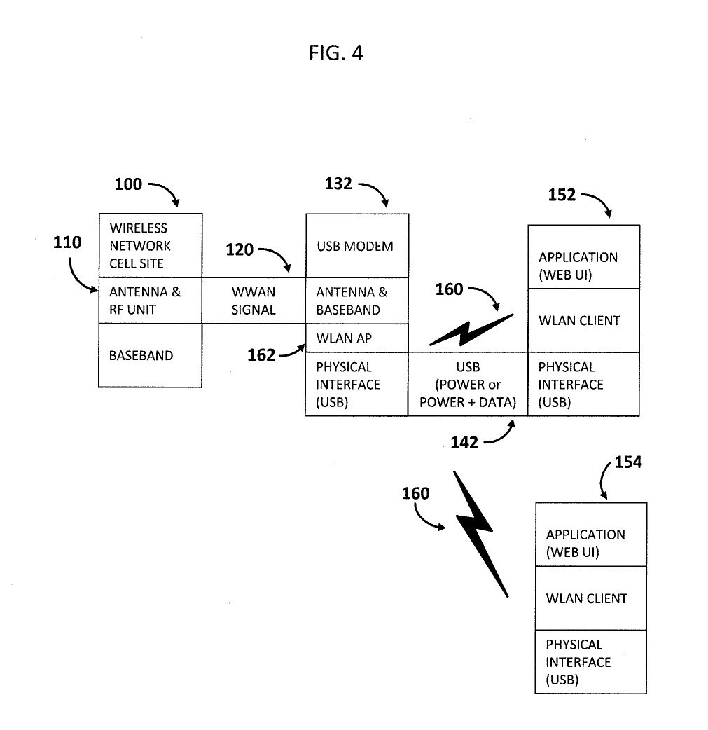

FIG. 3 is an embodiment of a wireless data communication network 20 that includes a wireless USB modem 132 according to one embodiment. FIG. 4 illustrates an exemplary data layer structure of the wireless data communication network 20 shown in FIG. 3. Although the USB protocol is described as an exemplary communication standard for the purpose of convenience, the wireless modem is not limited to use with any specific standard. That is, the wireless modem in this present disclosure is not limited to wireless USB modems.

The wireless data communication network 20 includes a client device 152 and a wireless network cell site 100 which wirelessly communicate data with each other via a WWAN signal 120. The client device 152 can be any computing device, including but not limited to, a desktop computer, a laptop computer, a tablet computer, a smart phone, a personal digital assistant or any other computing device that can communicate data with the USB modem 132.

In one embodiment, the USB modem 132 includes a physical USB interface 142 and a WLAN access point (AP) unit 162 (see FIG. 4). The physical USB interface 142 establishes a physical connection between the modem 132 and the client device 152. The WLAN AP unit 162 establishes a wireless link between the modem 132 and the client device 152 and/or at least one detached client device 154 via a WLAN signal 160. In the illustrated embodiment, a user may select one or both of the two interfaces 142 and 162 for the USB modem 132 to communicate data with the client device.

For example, if the USB modem 132 is physically connected to the client device 152 and the user selects the physical interface 142, the USB modem 132 performs data communication based on the selected physical interface. In one embodiment, upon the user's selection, the USB modem 132 receives power from the attached client device 152, and communicates data with the client device 152 via the physical USB interface 142 (“power + data communication” mode). In this embodiment, the user is prompted to install USB driver and CM programs, unless they are already installed in the client device 152.

In another embodiment, the USB modem 132 is physically connected to the client device 152 to receive power. In this embodiment, wired data communication between the USB modem 132 and the client device 152 is not required via the physical interface 142. Instead, the WLAN AP unit 162 allows the USB modem 132 to wirelessly communicate data with the client device 152 via the WLAN signal 160 while receiving power from the client device 152 (“power supply” mode). The advantage of this power supply mode is that there is no need to install a USB driver and a CM program in the client device 152.

The modem 132 can also communicate data with at least one detached client device 154 via the WLAN signal 160. In this mode, the wireless modem 132 does not need to be plugged into the client device 154 via the USB port, since the USB modem 132 allows the client device 154 to wirelessly communicate data with the wireless cell site 100 via the WLAN signal 160 and the WWAN signal 120. Although FIG. 3 shows only one additional client device 154, two or more additional client devices can also access and share the WLAN signal 160.

In this power supply mode, the USB modem 132 wirelessly communicates data with the attached client device 152 and/or at least one detached client device 154 via the WLAN signal 160, while receiving power from the client device 152. That is, even if the USB modem 132 is physically connected to the client device 152, the modem 132 can wirelessly communicate data with wireless units of the client devices 152 and 154, without having to install a USB driver and CM program in the client devices 152 and 154. Although WLAN has been described above, other short-range wireless networks such as Blue Tooth and Zigbee are also possible. Furthermore, the above embodiments can also be applied to any other wireless network which covers a limited area, for example, inside a commercial building or residence.

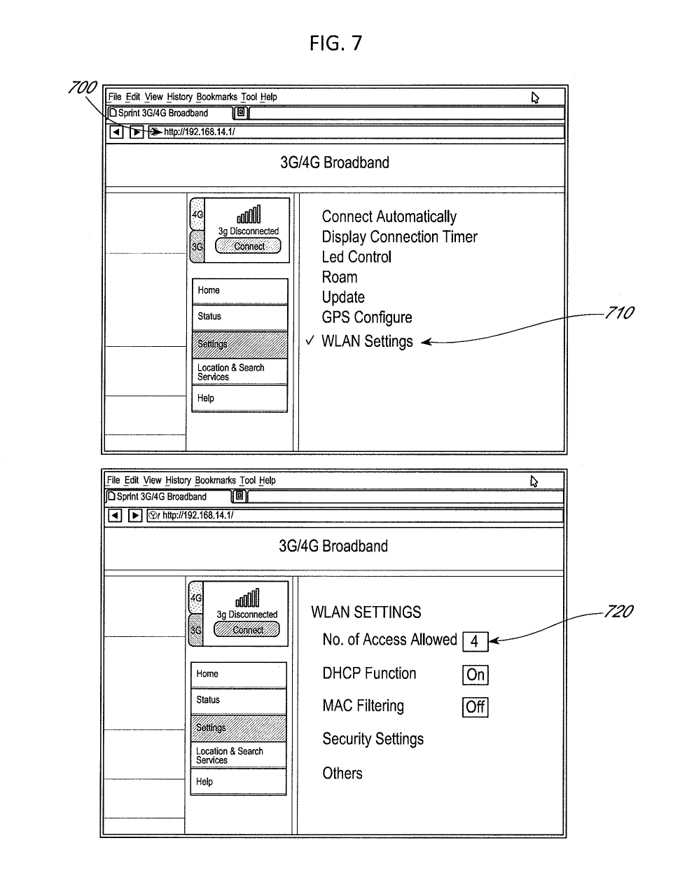

In one embodiment, the owner of the USB modem 132 uses a web user interface (UI) to limit the number of client devices accessing the USB modem 132 as shown in FIG. 7 (see the second screenshot of FIG. 7). The modem manufacturer may allow the web UI to be displayed on a commercial internet browser. In order to use the web UI, a user may type in a dedicated Internet protocol (IP) address (for example, http://192.168.14.1) or a dedicated domain name in the address window of an Internet browser such as Microsoft Internet Explorer or Google Chrome Browser, etc., to access a modem configuration screen on the client device 152.

The web UI screen of FIG. 7 allows a user to control and monitor menus indicative of the modem's operation status and wireless data communication status between the wireless cell site 100 and the client device 152. In one embodiment, as shown in FIG. 7, a user clicks the “WLAN settings” menu on the web UI 710 to open the WLAN settings sub menu. The user can type in the number of access allowance in the field named “No. of Access Allowed” 720. In FIG. 7, reference numeral 720 shows that the user has set the number of accessible client devices to four. Of course the user is not limited to four and can instead set a different number. The USB modem 132 may also set up, using the web UI program, security to require a user of a client device 152 to enter a password to access the WLAN USB interface using the WLAN signals 160 provided by the modem 132.

In another embodiment, a wireless USB modem 134 is physically connected to an external power source 170 (see FIG. 3). In this embodiment, the modem 134 can operate as a standalone device (e.g., as a portable WLAN Wi-Fi router) and does not need a physical connection with the client device 152. In one embodiment, the standalone modem 134 has the same configuration as the USB modem 132 so that the standalone modem 134 provides the physical interface 142 and a short-range wireless interface using, for example, the WLAN signal 160 when it is attached to a client device 152. In another embodiment, the USB modem 134 includes elements required only for the wireless interface function. In this embodiment, the USB modem 134 does not need to store a USB driver and CM program, and uses the physical USB interface 142 only for receiving power from the external power source 170 or the client device 152 connected thereto.

In one embodiment, the external power source 170 is a battery pack which has a USB female connector that can accept the counterpart of the USB modem 134. The battery pack can be charged with the use of a charging circuit or an electric power outlet. In another embodiment, the external power source 170 includes any device or machine that can be electrically wired or wirelessly connected to the USB modem for power supply via, for example, a regular size (type A) USB port provided in the modem 134. The USB modem 134 may additionally, or instead of the type A USB port, include a smaller USB port such as a mini B-type USB port or a micro B-type USB port. In this situation, the external power source 170 may include a smaller USB port corresponding to the smaller port of the USB modem 132.

When plugged into the external power source 170, the wireless USB modem 134 can establish a standalone hotspot modem without a physical connection with a client device. Again, multiple users can wirelessly connect their client devices 152 to the standalone USB modem 134 and can wirelessly communicate data with the wireless cell site 100 via the modem 134 and the WWAN signal 120.

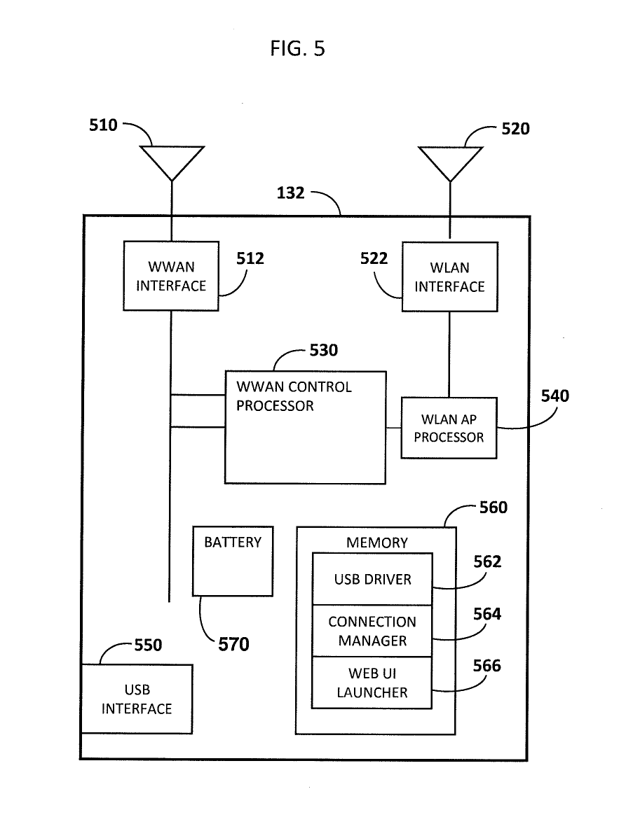

FIG. 5 illustrates a functional block diagram of the USB modem 132 according to one embodiment. The USB modem 132 includes a WWAN transmitter/receiver (or transceiver) 510, a WLAN transmitter/receiver (or transceiver) 520, a WWAN interface 512, a WLAN interface 522, a WWAN control processor 530, a WLAN AP processor 540, a USB interface 550, and a memory 560. Depending on the embodiment, additional elements may be added to and/or others removed from the modem 132 shown in FIG. 5.

The WWAN interface 512 allows the USB modem 132 to wirelessly communicate data with the wireless cell site 100 via the WWAN transceiver 510 once a WWAN data connection is established therebetween. WWAN includes all cellular communication networks, including but not limited to, GSM, CDMA, EVDO, HSPA, LTE and WiMax. Although FIG. 5 shows WLAN elements, other short-range wireless interfaces (e.g., Blue Tooth or Zigbee) can also be used. However, exemplary WLAN elements are used for the purpose of description. Furthermore, the standalone modem 134 may have the same configuration as the modem 132. For the purpose of convenience, the operation and configuration of the modem 132 will be described.

The WWAN control processor 530 may supervise the overall operation of the modem 132. For example, the WWAN control processor 530 may perform a signal conversion between WWAN data received from the cell site 100 and USB data received from the client device 152. The WWAN control processor 530 may also forward WWAN data received from the WLAN AP processor 540 to the WWAN interface 512 to be transmitted to the cell site 100 via the WWAN signal 120.

The WLAN interface 522 allows the USB modem 132 to wirelessly communicate data with a WLAN unit of the client device 152 or 154 via the WLAN transceiver 520 once the WLAN is established between the modem 132 and the client device 152 or 154. The WLAN AP processor 540 may control the WLAN operation of the modem 132. For example, the WLAN AP processor 540 may perform a signal conversion between WLAN data received from the client devices 152 and 154, and WWAN data received from the WWAN control processor 530.

In one embodiment, the WLAN control processor 530 is a master and the WLAN AP processor 540 is a slave. In another embodiment the WLAN AP processor 540 is the master and the WLAN control processor 530 is the slave. The WLAN control processor 530 and WLAN AP processor 540 may be incorporated into a single processor or multiple processors. In certain embodiments, the single processor 530 includes the memory 560.

In certain embodiments, the memory 560 includes a USB driver program 562, a connection manager program 564 and a web UI launcher 566. In another embodiment, the memory 560 does not store the USB driver program 562 and the connection manager program 564. The USB driver program 562 and connection manager program 564 may be prompted to be installed into the client device 152 by the WWAN control processor 530, when the user selects the physical USB interface 142 for data communication between the modem 132 and client device 152. The web UI launcher 566 may be prompted by the WWAN control processor 530 when the user selects the WLAN for data communication between the modem 132 and client devices 152 and 154. The web UI launcher 566 can monitor and control the operation status of the modem 132 according to a user's selection of the physical USB interface 142 or the WLAN.

In one embodiment, the USB modem 132 may include an internal battery 570. The battery 570 may compensate for any difference between the maximum power (e.g., about 500 mmAh) provided through the USB interface 550 and the maximum power intermittently required by the modem 132 during operation. For example, when the modem 132 is consuming less than the maximum power provided by the USB interface 550, the battery 570 is charged by the external power source 170 or the client device 152 connected thereto via the USB interface 550. Furthermore, when the USB modem 132 temporarily requires more power than the USB modem 132 can provide; the battery 570 discharges its power to maintain stable operation of the modem 132 or 134. In another embodiment, the modem 132 may use the internal battery 570 during normal operation.

In one embodiment, at least one of the USB modems 132 and 134 has the configuration of FIG. 5 so as to provide both the physical USB interface 142 and wireless USB interface using the WLAN signal 160. In another embodiment, at least one of the USB modems 132 and 134 is configured to provide only the wireless USB interface using the WLAN signal 160. In this embodiment, the USB modem 132 or 134 may not need the USB driver and CM software 562 and 564. Furthermore, the USB interface 550 may be used only for power supply provided from the computing device 152 or the external power source 170 connected thereto.

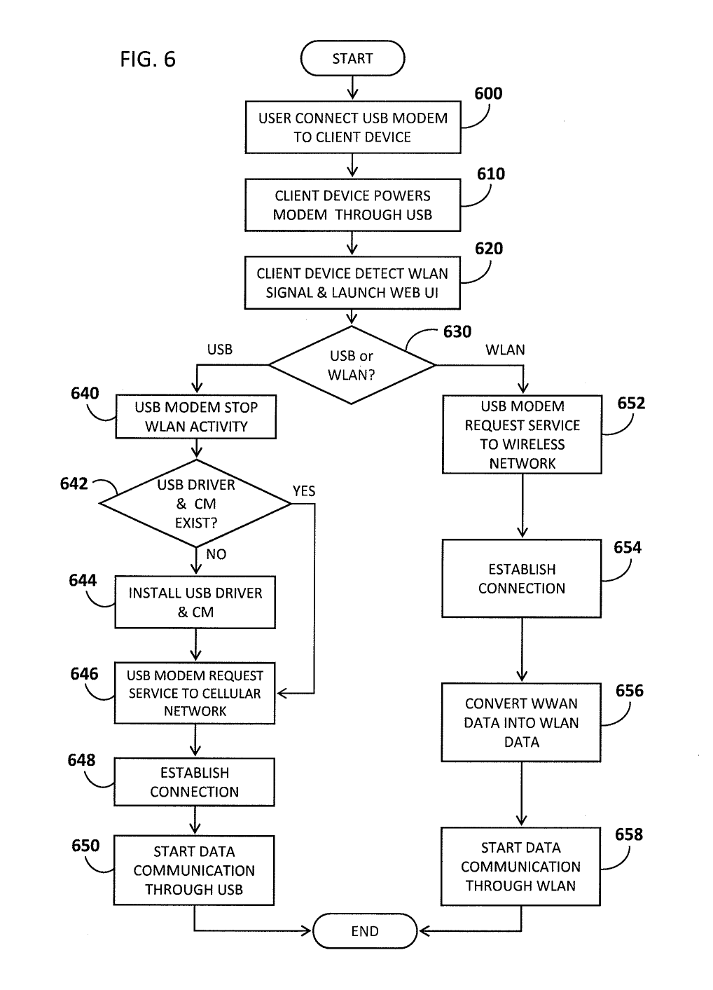

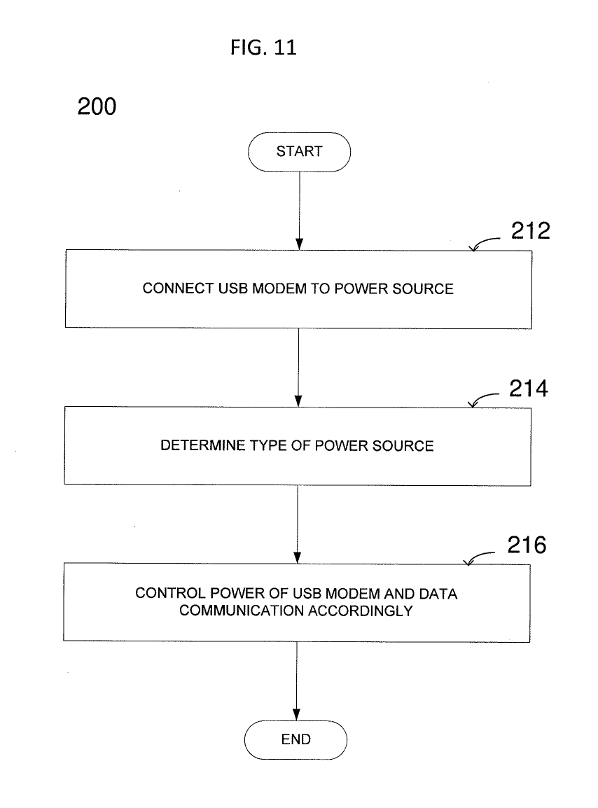

FIG. 6 is a flowchart showing one exemplary use and operation of the wireless USB modem 132, 134 from FIG. 3. In one embodiment, the FIG. 6 procedure (or at least part of the procedure) is implemented in a conventional programming language, such as C or C++ or another suitable programming language. In one embodiment, the program is stored on a computer accessible storage medium of the USB modem 132 or 134, for example, the memory 560 of FIG. 5. In another embodiment, the program can be stored in other system locations (e.g., client device 152 or 154) so long as it can perform at least part of the FIG. 6 procedure. In another embodiment, the program can be stored in a separate storage medium. The storage medium may comprise any of a variety of technologies for storing information. In one embodiment, the storage medium comprises a random access memory (RAM), hard disks, floppy disks, digital video devices, compact discs, video discs, and/or other optical storage mediums, etc. In another embodiment, at least one of the WWAN processor 530 and WLAN processor 540 is configured to or programmed to perform at least part of the FIG. 6 procedure. The program may be stored in the processor. In various embodiments, the processor may have a configuration based on, for example, i) an advanced RISC machine (ARM) microcontroller and ii) Intel Corporation's microprocessors (e.g., the Pentium family microprocessors). In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, the procedure can be implemented with embedded software. Depending on the embodiment, additional states may be added, others removed, or the order of the states changes in FIG. 6. This paragraph applies to the procedures 200-400 of FIGS. 11-13.

Referring to FIGS. 3-5 and 7, the FIG. 6 procedure will now be described. A user physically connects the USB modem 132 to the client device 152 (600). The client device 152 provides power to the attached USB modem 132 via the physical USB interface 142 (610). Once the modem 132 is powered, it transmits a WLAN signal to the client device 152 via the WLAN transceiver 520 (620). In one embodiment, the USB modem 132 coordinates with the cellular cell site 100 to establish a wireless packet data channel when the modem 132 is connected to the client device 152 and acquires power though the physical USB interface 142. The modem 132 activates the WLAN AP processor 540 to transmit a WLAN signal around the modem 132 via the WLAN transceiver 520.

When the client device 152 detects the WLAN signal, the modem 132 retrieves the web UI program 566 from the memory 560 and launches the web UI program 566 on the screen of the client device 152 to provide the user with a choice of data connection (630). In one embodiment, the user of the client device 152 is prompted to choose the physical USB interface 142 or the wireless USB interface using the WLAN signal 160 (630).

If it is determined in state 630 that the physical USB interface 142 has been selected as data transmission media (“physical USB interface” mode), the modem 132 may deactivate the WLAN function, including discontinuing transmission of the WLAN signal (640). Then, it is determined whether a USB driver program and a CM program are already installed in the client device 152 (642). In one embodiment, if it is determined in state 642 that there is no USB driver and CM programs installed, the modem 132 retrieves and installs the USB driver and CM software 562 and 564, stored in the memory 560, into the client device 152 (644). In another embodiment, the state 642 is omitted, and the USB modem 132 directly installs the USB driver and CM software 562 and 564 into the client device 152.

If it is determined in state 642 that a USB driver and a CM software are already installed, or after the modem 132 installs the USB driver and CM software into the client device 152, the modem 132 requests a WWAN connection to the commercial cellular cell site 100 to which the user subscribes (646). Once the WWAN connection is established between the USB modem 132 and the cellular cell site 100 (648), the modem 132 starts data communication by, for example, converting WWAN data into USB data, and transmitting the USB data to the client device 132 via the physical USB interface 142 (650). In this mode, the physical USB interface 142 is used for both power supply and data transfer between the USB modem 132 and the client device 152. Furthermore, the modem 132 can be accessed only by the client device 152 physically connected thereto.

If it is determined in state 630 that the WLAN interface has been selected, the modem 132 maintains the WLAN connection with the client device 152 and requests a WWAN connection from the commercial cellular cell site 100 (“WLAN interface” or “wireless interface” mode) (652). Once the WWAN connection is established (654), the modem 132 performs the WLAN interface, including converting the WWAN signal into the WLAN signal and vice versa (656, 658).

The USB modem 132 or 134 receives power from the client device 152 connected thereto or the external power source 170. In this WLAN interface mode, the user does not need to install a USB driver and CM software into the client device 152. The USB modem 132 or 134 can function as a standalone modem if it is connected to the external power source 170. As described above, at least one other client device 154 also has access to the USB modem 132 or 134 via the WLAN interface. Furthermore, the user of the client device 152 or the owner of the modem 132 or 134 can limit the number of accessible client devices through the WEB UI screen as shown in FIG. 7.

The USB modem according to at least one of the above embodiments has the following advantages over the USB modem described with respect to FIGS. 1 and 2. While the USB modem of FIGS. 1 and 2 is used by only one client device attached thereto, the USB modem according to at least one embodiment can be plugged into either a client device or a separate power source. Furthermore, while the USB modem of FIGS. 1 and 2 can communicate data with only the attached client device, the USB modem according to at least one embodiment can provide data connection to the attached client device and detached client devices which are located within short-range wireless interface coverage such as WLAN, Blue Tooth or Zigbee.

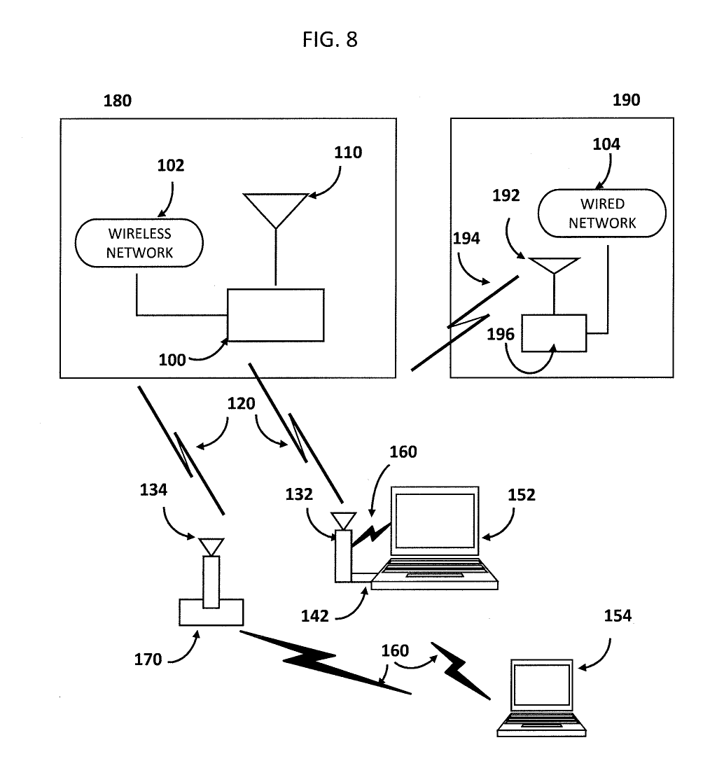

FIG. 8 is a wireless data communication network including a wireless USB modem configured to provide wireless data communication between client devices and wireless networks according to one embodiment. The wireless data communication network includes a WWAN 180 and a WLAN 190. The WWAN 180 includes the network cell site 100 having an RF unit 110. The network cell site 100 may be a base station that is connected to a wireless network 102. The wireless network 102 may include cellular communication networks, including but not limited to, GSM, CDMA, EVDO, HSPA, LTE and WiMax.

The WLAN 190 includes a public or private access point (AP) 196 having an RF unit 192 that is connected to a wired network 104. The wireless modems 132 and 134 may wirelessly communicate data with the base station of the WWAN 180 via a WWAN signal 120. The wireless modem 132 may wirelessly communicate data with the AP 196 of the WLAN 190 via a WLAN signal 194.

In some embodiments, when the wireless USB modem 132 is physically connected to the USB interface 142 of the computing device 152, the modem 132 may receive a first power from the computing device 152. The first power may not exceed the maximum power that the computing device 152 can provide to the modem 132. In some embodiments, when the wireless USB modem 134 is physically connected to the USB port of the external power source 170, the modem 134 may receive a second power from the external power source 170. The second power may be a sufficient operational power for the modem 134 such that at least one of wireless transceivers of the wireless interface 202 (e.g., WWAN and WLAN transceivers) can wirelessly transmit data at its maximum power level. The first power may be different in magnitude from the second power. For example, the second power may be greater than the first power.

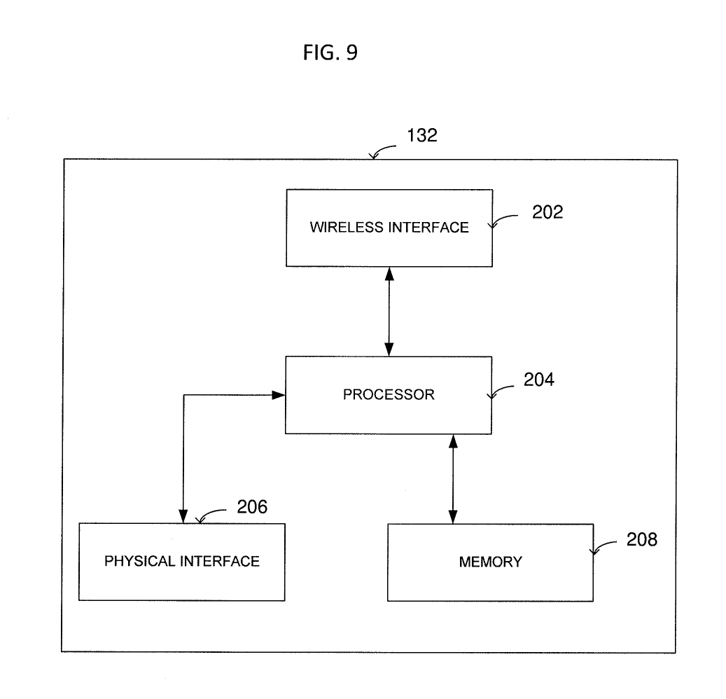

FIG. 9 is a functional block diagram of one embodiment of the wireless USB modem 132 from FIG. 8. The wireless USB modem 132 includes a wireless interface 202, a processor (hereinafter, interchangeably used with a controller) 204, a physical interface 206 and a memory 208. Depending on the embodiment, certain elements may be removed from or additional elements may be added to the wireless modem 132 illustrated in FIG. 9. Furthermore, two or more elements may be combined into a single element, or a single element may be realized as multiple elements. For example, the memory 208 may be incorporated into the processor 204. The wireless interface 202 may be realized as a plurality of wireless interfaces such as a WWAN interface and a WLAN interface. The processor 204 may be realized as a plurality of processors such as a WWAN processor and a WLAN processor. The wireless USB modem 134 may have the same configuration as the USB modem 132. This applies to the remaining embodiments.

The wireless interface 202 may be any wireless interface that can communicate data with a wireless communication network. In some embodiments, the wireless interface 202 includes at least one of a WWAN interface and a WLAN interface. In these embodiments, the WWAN interface may include a WWAN transceiver. Furthermore, the WLAN interface may include a WLAN transceiver.

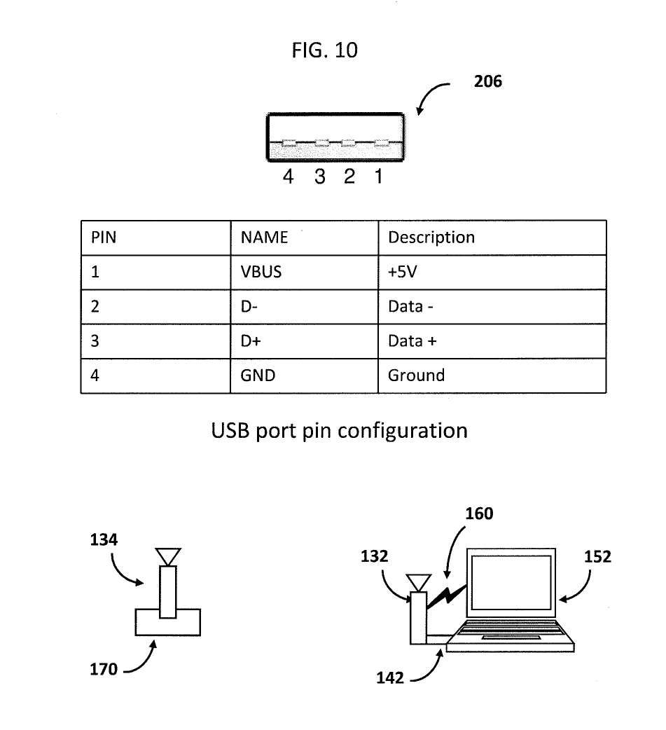

The physical interface 206 may be any physical interface that can be connected to any computing device or any external power source. In some embodiments, the physical interface 206 includes a USB interface. As shown in FIG. 10, the USB interface may include four pins (1-4). Pins 2 and 3 are assigned as a data pin that is configured to receive data from a computing device such as the computing device 152. Pins 1 and 4 are assigned as a power pin that is configured to receive power from a plurality of power sources including, but not limited to, the computing device 152 and the external power source 170. The pin configuration as shown in FIG. 10 reflects the current USB interface standard. However, different pin configurations may also be possible, for example, as long as there are at least one data pin and at least one power pin.

In some embodiments, the controller 204 determines a type of power source that provides power to the modem 132. For example, the controller 204 may determine that the USB modem 132 is connected to the computing device 152 when the controller 204 detects all of the pins 1-4 or at least one data pin. Furthermore, the controller 204 may determine that the USB modem 132 is connected to the external power source 170 when the controller 204 detects only the pins 1 and 4 or at least one power pin.

In some embodiments, the controller 204 may determine a type of power source depending on the magnitude of a detected electrical signal such as a voltage or current. For example, if the magnitude of a detected current is substantially equal to or less than a certain reference value (e.g., about 500 mA), the controller 204 may determine that the modem 132 is connected to the computing device 152. In this example, if the magnitude of a detected current is greater than the certain reference value, the controller 204 may determine that the modem 132 is connected to the external power source 170. In these embodiments, the modem 132 may include a current detector that is electrically connected to at least one pin of the physical interface 206 and detects the amount of current received from the connected computing device 152 or external power source 170.

In some embodiments, the controller 204 selects a transmission power level of the wireless interface 202 based at least partially on the determined type of power source. For example, the controller 204 selects a first transmission power level of the wireless interface 202, when the modem 132 is connected to the computing device 152. The controller 204 may select a second transmission power level of the wireless interface 202 which is greater than the first transmission power level, when the modem 132 is connected to the external power source 170. The controller 204 may dynamically select a transmission power level of the wireless interface 202 based on various factors including, but not limited to, a received signal strength and a type of wireless transceiver (WWAN transceiver or WLAN transceiver).

The transmission power level of the wireless interface 202 may be predetermined. The predetermined transmission power level may be stored in the memory 208 or controller 204. For example, if the wireless interface 202 is a WLAN transceiver, the first transmission power level is pre-assigned and stored in the modem 132. As another example, if the wireless interface 202 is a WWAN transceiver, the second transmission power level which is greater than the first transmission power level is pre-assigned and stored in the modem 132.

The memory 208 may store a program that controls the overall operation of the modem 132. The program may be executed by the processor 204. The memory 208 may store part of the control program and the processor 204 may store the remaining program. In this embodiment, the combination of the processor 204 and the memory 208 executes the entire program. The memory 208 may be incorporated into the processor 204. In one embodiment, the processor 204 is implemented with a variety of computer platforms using a single chip or multichip microprocessors, digital signal processors, embedded microprocessors, microcontrollers, etc. In another embodiment, the processor 204 is implemented with a wide range of operating systems such as Unix, Linux, Microsoft DOS, Microsoft Windows 7/Vista/2000/9x/ME/XP, Macintosh OS, OS/2, Android, iOS and the like.

FIG. 11 is a flowchart showing another exemplary use and operation of the wireless USB modem from FIG. 8. As discussed above, depending on the embodiment, additional states may be added, others removed, or the order of the states may change in FIG. 11. Referring to FIGS. 8-10, the FIG. 11 procedure 200 will be described.

In state 212, the USB modem 132, 134 is connected to a power source that provides power to the modem 132, 134. As discussed above, the power source can be the computing device 152 or the external power source 170. The power source can be connected to the USB modem 132/134 via the physical interface 206. The power source may be an external USB power source such as a portable battery pack with USB connectors, an alternate current (AC)-to-USB converter, an automobile/aircraft USB port, an automobile cigar lighter port with a USB charger and an adapter that has USB connectors and is plugged into an electrical outlet.

In state 214, the modem 132, 134 (hereinafter, to be interchangeably used with the processor 204) determines a type of power source that is connected to the modem 132, 134. As discussed above, the controller 204 may determine the type of power source connected to the modem 132, 134 based at least partially on whether or not the processor 204 detects at least one data pin of the USB interface 206.

In state 216, the processor 204 controls an operational power of the USB modem 132, 134. In some embodiments, the processor 204 may select the first or second transmission power level of the wireless interface 202 as described above depending on which power source the modem 132, 134 is connected to. In another embodiment, the processor 204 may select a transmission power level of the wireless interface 202 based on the strength of a signal received by the modem 132, 134. Thereafter, the modem 132, 134 may communicate data with at least one of the WWAN 180, WLAN 190 and the computing device 152, 154 using the selected transmission power level.

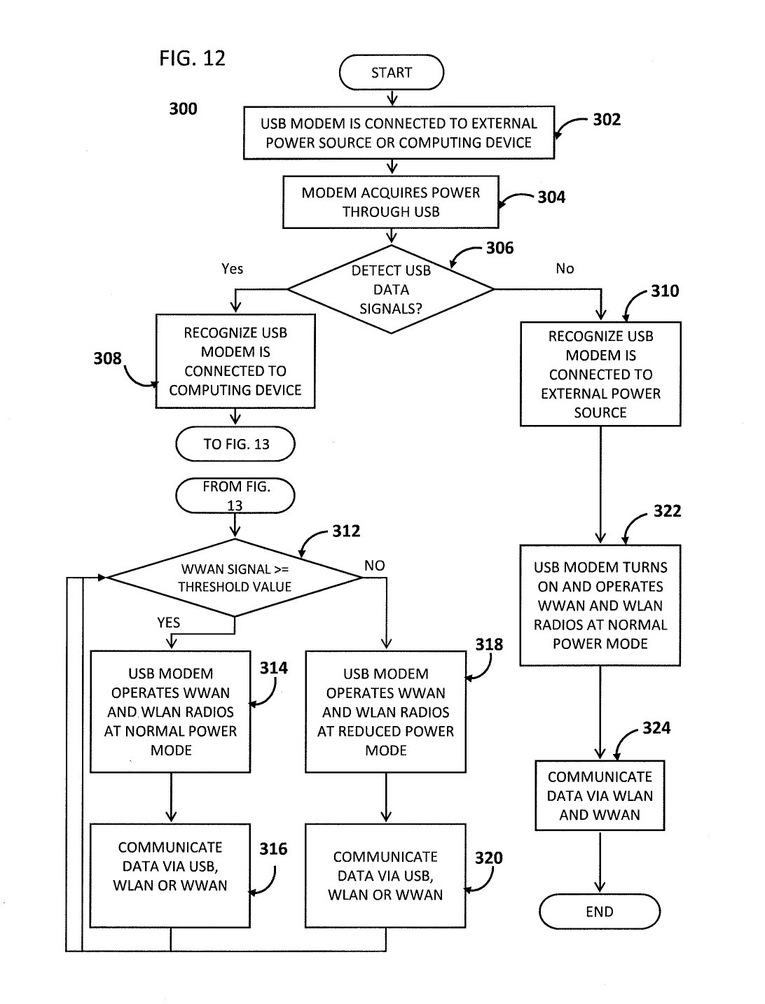

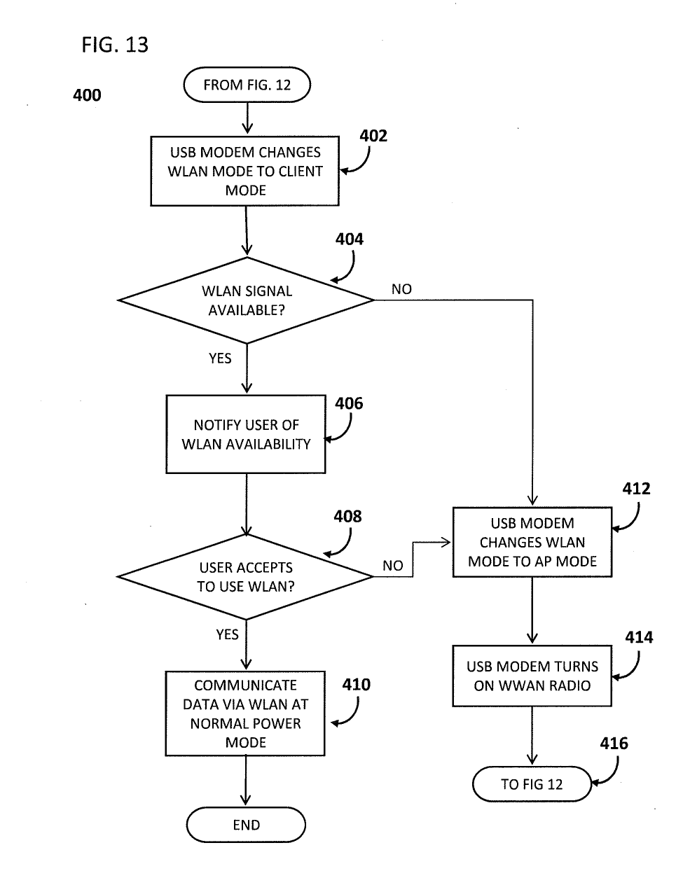

FIG. 12 is a flowchart showing another exemplary use and operation of the wireless USB modem from FIG. 8. FIG. 13 is a flowchart showing another exemplary use and operation of the wireless USB modem from FIG. 8. As discussed above, depending on the embodiment, additional states may be added, others removed, or the order of the states may change in FIGS. 12 and 13. For example, the entire procedure 400 of FIG. 13 may be omitted. Referring to FIGS. 8-10 and 14, the procedures 300 and 400 of FIGS. 12 and 13 will be described.

In state 302, the USB modem 132, 134 is connected to either the external power source 170 or the computing device 152. In state 304, the modem 132, 134 acquires power from the USB port of the power source connected thereto. In state 306, the processor 204 of the modem 132, 134 determines whether USB data signals are detected, for example, via at least one data pin of the USB interface 206 as shown in FIG. 10.

If the processor 204 determines that USB data signals are not detected, for example, when a connection to only a power pin is detected, the processor 204 recognizes that the modem 134 is connected to the external power source 170 (state 310). In this embodiment, the modem 134 can operate as a standalone device and does not need a physical connection with the computing device 152, 154. For example, the modem 134 may function as a portable Wi-Fi router or a Wi-Fi hot-spot for computing devices in the WLAN network such as the computing device 154. As shown in FIG. 8, the modem 134 may wirelessly communicate data with the WWAN 180 via the WWAN signal 120 or the computing device 154 via the WLAN signal 160.

In state 322, the USB modem 134 turns on and operates WWAN and WLAN radios (e.g., WWAN and WLAN transceivers) at a normal power mode. In the normal power mode, the external power source 170 may provide a sufficient operational power to the modem 134 such that at least one of the WWAN and WLAN transceivers can wirelessly transmit data at its maximum power level. In state 324, the USB modem 134 wirelessly communicates data with the WWAN 180 via the WWAN signal 120 and the computing device 154 via the WLAN signal 160.

If the processor 204 determines that USB data signals are detected, for example, when at least one data pin is detected or all of the pins 1-4 are detected, the processor 204 recognizes that the modem 132 is connected to the computing device 152 (state 308).

In state 402 (see FIG. 13), the USB modem 132 changes a WLAN mode to a client mode. In some embodiments, the modem 132 turns on a WLAN radio (e.g., WLAN transceiver) before it changes to the client mode. In state 404, the USB modem 132 determines whether a (public or private) WLAN signal is available. For example, the USB modem 132 may search for the WLAN signal 194.

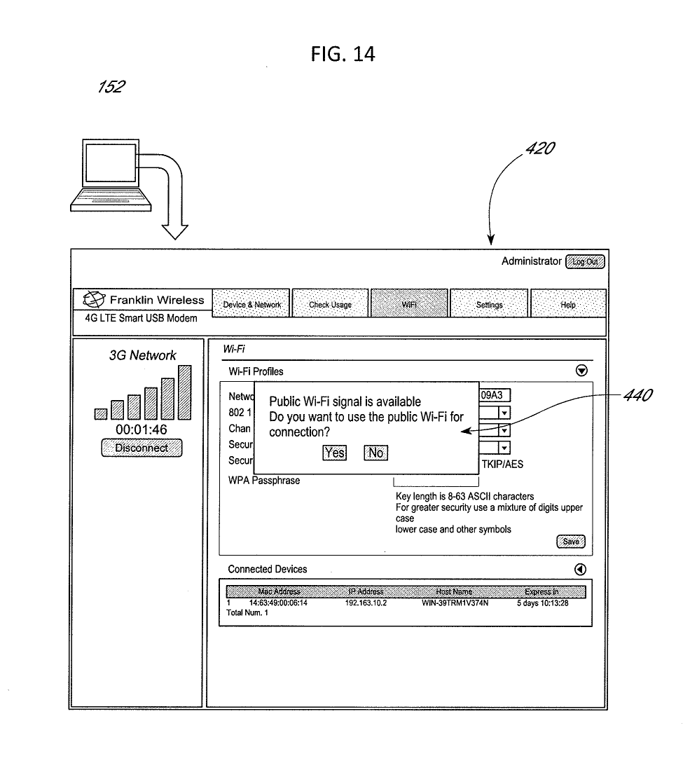

If the WLAN signal 194 is available, the modem 132 notifies a user of the computing device 152 of the WLAN availability (state 406). FIG. 14 illustrates an exemplary screenshot of a pop-up notification that is displayed on a screen of a client device by the wireless USB modem from FIG. 8. In some embodiments, the modem 132 may control the computing device 152 to display a pop-up notification 440 via a Web-UI 420.

In state 408, the modem 132 determines whether the user accepts use of the available WLAN. If the user accepts use of the WLAN, the USB modem 132 may keep the client mode and connect to the detected public or private WLAN 190. Furthermore, the USB modem 132 need not turn on its WWAN transceiver.

The modem 132 wirelessly communicates data with the computing device 152 and/or the WLAN 190 at a normal power mode (state 410). Since the WLAN transceiver generally does not consume a large amount of power, the modem 132 can safely operate the WLAN transceiver without causing the risk of the computing device 152 being shut down due to a power shortage. If there is no WLAN signal available in state 404 or if the user does not accept use of WLAN 190 in state 408, the modem 132 changes the WLAN mode from the client mode into an AP mode (state 412). In state 414, the modem 132 turns on the WWAN radio (e.g., WWAN transceiver).

Returning to FIG. 12, in state 312, the modem 132 determines whether the strength of the WWAN signal 120 received from the WWAN 180 (see FIG. 8) is substantially equal to or greater than a threshold value. In some embodiments, the modem 132 continues to measure the strength of the received WWAN signal 120 and compares it with the threshold value. In some embodiments, the threshold value is between about −104 dBm and about −90 dBm. In another embodiment, the threshold value may be greater than about −90 dBm or less than about −104 dBm. Here, “−” sign means a signal received by the modem 132 rather than transmitted from the modem 132.

If the strength of the received WWAN signal 120 is substantially equal to or greater than the threshold value in state 312, the USB modem 132 operates the WWAN and WLAN radios at a normal power mode (state 314). For example, if the WWAN base station 100 is relatively close to the USB modem 132, the strength of the received WWAN signal 120 may be substantially equal to or greater than the threshold value. In this scenario, the modem 132 may not need a higher transmission power level to communicate data with the WWAN 180. Thus, the power consumption by the modem 132 may not exceed the maximum power that the computing device 152 can provide to the modem 132, even if the modem 132 operates at a normal power mode.

In some embodiments, the modem 132 selects the transmission power level to be substantially disproportionate to the strength of the received signal. For example, if the strength of the received signal is relatively high (which means that the base station 100 is relatively close to the modem 132), the modem 132 may use a relatively low power transmission level. Thereafter, the modem 132 communicates data with 1) the computing device 152 via the USB interface 206 or the WLAN signal 160, 2) the WWAN 180 via the WWN signal 120, or 3) the WLAN 190 via the WLAN signal 194.

If the strength of the received WWAN signal 120 is less than the threshold value in state 312, the USB modem 132 operates the WWAN and WLAN radios at a reduced power mode (state 318). For example, if the WWAN base station 100 is relatively far from the USB modem 132, the strength of the received WWAN signal 120 may be less than the threshold value. In this scenario, the modem 132 may need a higher transmission power level that may exceed the maximum power level that the computing device 152 can provide. However, if the modem 132 uses more than the maximum power that the computing device 152 can provide, the computing device 152 may unexpectedly be shut down due to a power shortage.

In some embodiments, the modem 132 reduces the combined power level of the WWAN and WLAN radios to be less than or equal to the maximum power so as to avoid such an undesirable result. Thereafter, the modem 132 communicates data with at least one of 1) the computing device 152 via the USB interface 206 or the WLAN signal 160, 2) the WWAN 180 via the WWAN signal 120 and 3) the WLAN 190 via the WLAN signal 194. In some embodiments, the states 312-320 are performed multiple times. In another embodiment, the procedure 300 may end after the states 316 and 320 have been performed once.

According to at least one of the disclosed embodiments, the wireless modem can determine whether its physical interface has a power limit or not and control its power consumption within the maximum power that the modem can retrieve from a host computer connected thereto. In addition, the wireless modem can offload WLAN traffic to a public WLAN traffic by interchanging its WLAN logic into a WLAN client mode or a WLAN AP mode. Furthermore, the wireless modem can determine whether it is connected to an USB port of a computing device or whether it is connected to an USB port of an external USB power source, and choose different operation modes accordingly.

Moreover, the wireless modem can automatically control the transmission power levels of the WWAN and WLAN radios according to the strength of a WWAN signal received from a base station in order to remain a power consumption level within the maximum power that a computing device can provide to the modem via a physical interface. This can prevent the computing device from being unexpectedly shut down due to a power shortage.

While the above description has pointed out features of various embodiments, the skilled person will understand that various omissions, substitutions, and changes in the form and details of the device or process illustrated may be made without departing from the scope of the appended claims.

What is claimed is:

1. A wireless universal serial bus (USB) modem comprising:
a physical USB interface configured to receive power from a power source, wherein the power source is a computing device or an external power source;
a wireless wide area network (WWAN) transceiver configured to transmit and receive WWAN data according to a WWAN communication standard;
a wireless local area network (WLAN) transceiver configured to transmit and receive WLAN data according to a WLAN communication standard; and
a controller configured to determine the power source that provides power via the physical USB interface and select a transmission power level of each of the WWAN and WLAN transceivers based at least partially on the determined power source.

2. A wireless modem comprising:
at least one wireless interface configured to wirelessly communicate data according to a wireless communication standard, wherein the at least one wireless interface is further configured to use a transmission power to transmit the data; and
a controller configured to determine a type of power source for the wireless modem and select a transmission power level of the at least one wireless interface based at least partially on the power source.

3. The modem of claim 2, further comprising a physical interface configured to receive power from one of a plurality of power sources.

4. The modem of claim 3, wherein the physical interface is a universal serial bus (USB) interface that comprises at least one data pin and at least one power pin.

5. The modem of claim 4, wherein the power sources comprise a computing device and an external power source.

6. The modem of claim 5, wherein the controller is further configured to determine that the power source is the external power source, when the external power source is connected to only the at least one power pin of the USB interface.

7. The modem of claim 6, wherein the controller is further configured to select the transmission power level to be greater than a reference power level.

8. The modem of claim 7, wherein the selected transmission power level is the maximum transmission power level of the wireless interface.

9. The modem of claim 5, wherein the controller is configured to determine that the power source is the computing device, when the computing device is connected to at least the data pin of the USB interface.

10. The modem of claim 9, wherein the controller is further configured to determine whether the strength of a signal received by the wireless interface is substantially equal to or greater than a threshold value.

11. The modem of claim 10, wherein the controller is further configured to select the transmission power level so as not to exceed the maximum power that the computing device can provide to the modem, if the strength of the received signal is less than the threshold value.

12. The modem of claim 10, wherein the controller is further configured to select the transmission power level to be substantially disproportionate to the strength of the received signal, if the strength of the received signal is substantially equal to or greater than the threshold value.

13. The modem of claim 5, wherein the external power source comprises at least one of the following: a portable battery pack with USB connectors, an alternate current (AC)-to-USB converter, an automobile/aircraft USB port, an automobile cigar lighter port with a USB charger and an adapter that has USB connectors and is configured to be plugged into an electrical outlet.

14. The modem of claim 1, wherein the transmission power level is predetermined.

15. The modem of claim 1, wherein the wireless interface comprises:
a wireless wide area network (WWAN) transceiver configured to transmit and receive WWAN data according to a WWAN communication standard; and
a wireless local area network (WLAN) transceiver configured to transmit and receive WLAN data according to a WLAN communication standard.

16. The modem of claim 15, wherein the controller is further configured to select the transmission power level based at least partially on at least one of a received signal strength and a type of wireless transceiver.

17. The modem of claim 16, wherein the controller is further configured to select the transmission power level of the WWAN transceiver to be greater than that of the WLAN transceiver.

18. A method of operating a wireless modem comprising:
wirelessly communicating data according to a wireless communication standard with the use of a transmission power to transmit the data;
determining a type of power source for the wireless modem; and
selecting a transmission power level for the wireless data communication based at least partially on the determined power source.

19. The method of claim 18, further comprising receiving a power from one of a plurality of power sources via a physical interface of the wireless modem.

20. The method of claim 19, wherein the plurality of power sources comprises a computing device and an external power source.

21. The method of claim 19, further comprising determining whether a data signal is detected at the physical interface.

22. The method of claim 21, wherein the power source is determined as the external power source, when the data signal is not detected at the physical interface.

23. The method of claim 22, wherein the transmission power level is selected to be greater than a reference power level.

24. The modem of claim 23, wherein the selected transmission power level is the maximum transmission power level for the wireless data communication.

25. The method of claim 21, wherein the power source is determined as the computing device, when the data signal is detected at the physical interface.

26. The method of claim 25, further comprising determining whether the strength of a signal received by the wireless modem is substantially equal to or greater than a threshold value.

27. The method of claim 26, wherein the transmission power level is selected so as not to exceed the maximum power that the computing device can provide to the modem, if the strength of the received signal is less than the threshold value.

28. The method of claim 25, further comprising:
changing a mode of the wireless modem to a client mode;
determining whether a wireless local area network (WLAN) signal is available;
if the WLAN signal is available, controlling the computing device to provide the WLAN availability to a user of the computing device; and
determining whether the user accepts use of the WLAN.

29. The method of claim 28, further comprising, if the user accepts use of the WLAN, communicating WLAN data at a normal power mode of the modem, wherein the normal power mode comprises a selection of the transmission power level up to the maximum power that the computing device can provide to the modem.

30. The method of claim 28, further comprising, if the user does not accept use of the WLAN or if the WLAN signal is not available:
changing the client mode to an access point mode; and
communicating wireless wide area network (WWAN) data with a WWAN.

31. The method of claim 30, further comprising determining whether the strength of the WWAN signal received by the wireless modem is substantially equal to or greater than a threshold value.

32. The method of claim 30, wherein the transmission power level is selected so as not to exceed the maximum power that the computing device can provide to the modem, if the strength of the received signal is less than the threshold value.

33. The method of claim 30, wherein the transmission power level is selected to be substantially disproportionate to the strength of the received signal, if the strength of the received signal is substantially equal to or greater than the threshold value.

34. The method of claim 18, wherein the transmission power level is selected based at least partially on at least one of a received signal strength and a type of the at least one wireless interface.

35. One or more processor-readable storage devices having processor-readable code embodied on the processor-readable storage devices, the processor-readable code for programming one or more processors to perform a method of operating a wireless modem comprising:
wirelessly communicating data according to a wireless communication standard with the use of a transmission power to transmit the data;
determining a type of power source for the wireless modem; and
selecting a transmission power level for the wireless data communication based at least partially on the determined power source.

36. A wireless modem comprising:
means for wirelessly communicating data according to a wireless communication standard with the use of a transmission power to transmit the data;
means for determining a type of power source for the wireless modem; and
means for selecting a transmission power level for the wireless data communication based at least partially on the determined power source.
